(19) United States
(12) Patent Application Publication
(10) Pub. No.: US 2002/0143628 A1
(43) Pub. Date: Oct. 3, 2002

(54) System and method for inserting advertising into user-selected web content

(76) Inventor: Byung Joon Park, Ulsan (KR)

Correspondence Address: SQUIRE, SANDERS & DEMPSEY L.L.P, 600 HANSEN WAY, PALO ALTO, CA, 94304-1043, US

(21) Appl. No.: 09/917,510

(22) Filed: Jul. 27, 2001

Related U.S. Application Data
(60) Provisional application No. 60/305,332, filed on Jul. 13, 2001.

(30) Foreign Application Priority Data
Apr. 2, 2001 (KR) 2001-0017437

(51) Int. Cl. G06F 17/60

(52) U.S. Cl. 705/14

(57) ABSTRACT

A system for inserting advertising into user-selected web content comprises a client engine and an advertising engine. The client engine is capable to aggregate user-selected content from multiple web pages into a file and to view files having aggregated content. The advertising engine is capable to displaying advertising whenever the client engine displays the aggregated content.

### PRIORITY REFERENCE TO PRIOR APPLICATION

This application claims benefit of Korean patent application serial number 2001-0017437, entitled “A Method and System for Providing Advertisement Service by Using the Internet,” filed on Apr. 2, 2001, by inventor Byung Joon Park. Further, this application claims benefit of and incorporates by reference U.S. patent application Ser. No. 60/______, entitled “DMWV Systems and Methods,” filed on Jul. 13, 2001, by inventor Byung Joon Park.

### TECHNICAL FIELD

This invention relates generally to inserting advertising, and more particularly, but not exclusively, provides a system and method for inserting advertising into user-selected web content.

### BACKGROUND

Advertising is an important technique for generating revenue for companies. For example, transit companies supplement revenue from fares with advertisements on their vehicles; print companies supplement their revenue from subscriptions with advertisements in their magazines and newspapers; and, especially, Internet companies supplement their revenue from banner advertisements.

Accordingly, as Internet companies depend on advertisements for a high percentage of their revenues, if not their sole source, a new and improved system and method are needed for inserting advertising into web content.

### SUMMARY

The present invention provides a system for inserting advertising into user-selected web content. The system, which is communicatively coupled to a network, comprises a client-based engine that enables a user to select portions of a web page and save the selected portions into a file by calculating coordinates of the selected portions and storing the coordinates and associated web page address in the file. When a user loads the file, the engine loads the entire web page specified by the web address but filters the web page so as to display only content specified by the stored coordinates. In addition, during display of the user-selected content, the engine loads and displays one or more advertisements with the user-selected content. In one embodiment, the advertisements can be stored on an ad server and the engine may download an advertisement concurrently with downloading the web page. Alternatively, advertisements may be stored locally and the engine may select and display one or more of the locally stored advertisements.

The present invention further provides a method of inserting advertising into user-selected web content, comprising: requesting advertisements to store locally, receiving and locally storing the requested advertisements, opening a file having user-selected web content; and displaying one or more advertisements from an ad server and/or a locally stored library of advertisements.

Accordingly, the system and method may advantageously insert advertising into user-selected web content.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a network topography in accordance with an embodiment of the invention;

FIG. 2 is a block diagram illustrating a client computer of FIG. 1.;

FIG. 3 illustrates a block diagram of a memory device of FIG. 2 according to an embodiment of the invention;

FIG. 4 is a block diagram illustrating a server of FIG. 1 according to an embodiment of an invention;

FIG. 5 is a block diagram illustrating a memory device of FIG. 4 according to an embodiment of the invention;

FIG. 6 is a flowchart illustrating a method of inserting advertising into user-selected web content; and

FIG. 7 is a diagram illustrating an example of inserted advertising.

### DETAILED DESCRIPTION OF THE ILLUSTRATED EMBODIMENTS

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

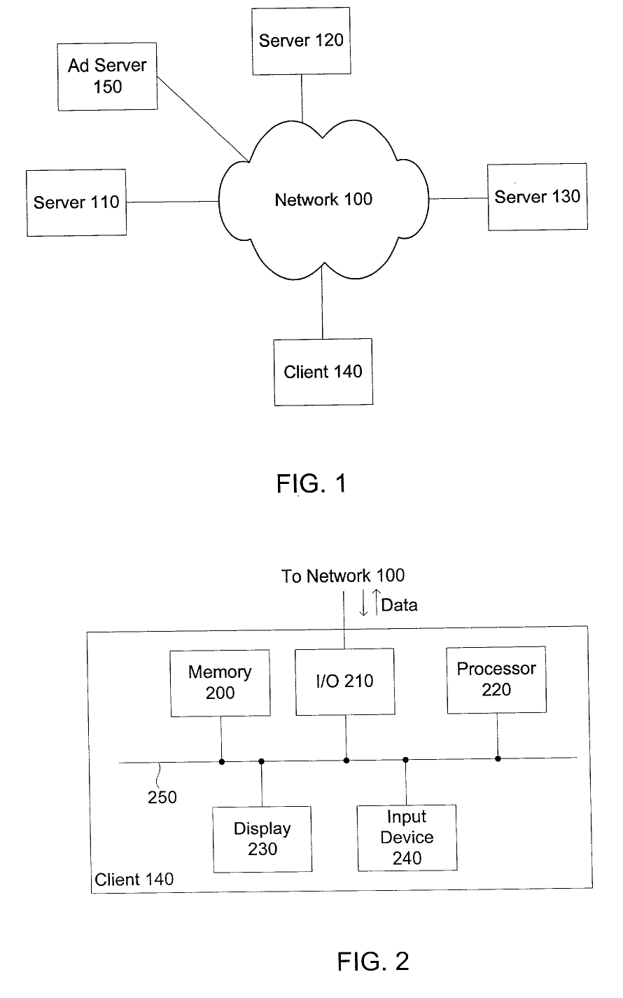

FIG. 1 is a block diagram illustrating a network topography according to an embodiment of the invention. The topography includes servers 110, 120 and 130, client 140, and ad server 150 communicatively coupled to a network 100, such as the Internet. Servers 110, 120 and 130 may include web servers hosting web pages. Client 140 may include a personal digital assistant (“PDA”), wireless phone, computer, or any other device capable to communicate with a network. Ad server 150 may be a server having a library of at least one advertisement, as will be discussed in further detail in conjunction with FIG. 4 and FIG. 5. Further, although only four servers and one client are shown coupled to the network, in an embodiment of the invention, any number of clients and servers may be coupled to the network 100.

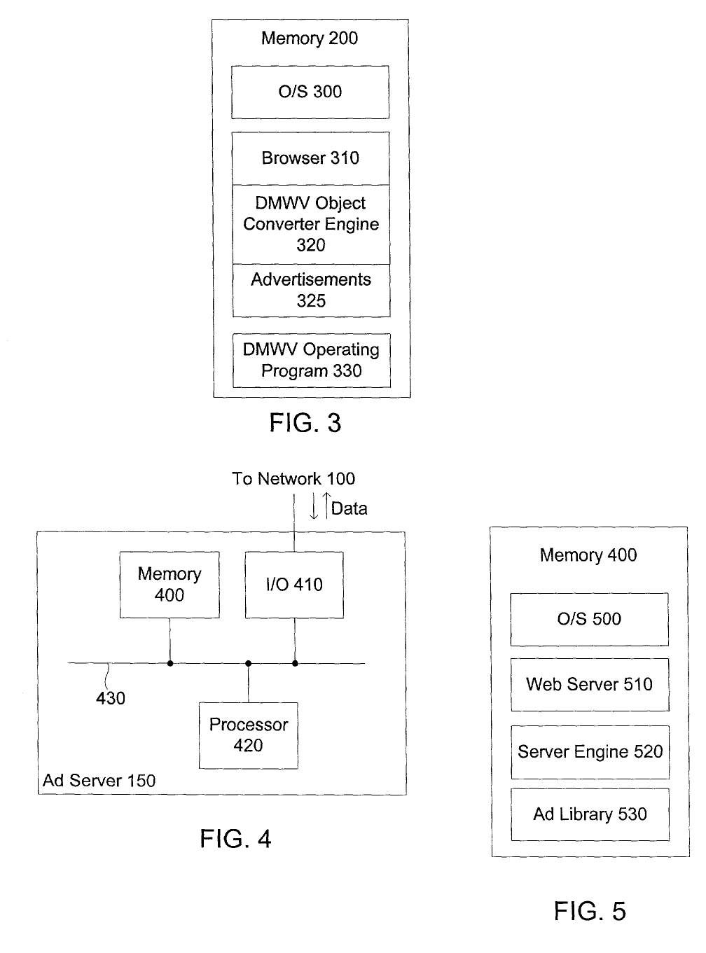

FIG. 2 is a block diagram illustrating a client 140 in accordance with an embodiment of the invention. The client 140 includes a memory device 200, input/output (I/O) interface 210, processor 220, display 230, and input device 240, all communicatively coupled together via system bus 250. In an embodiment of the invention, memory 200 may include RAM, ROM, FLASH memory, a hard drive, disk drive, or any other type of memory device or combination of memory devices. The contents of memory 200 will be discussed in further detail in conjunction with FIG. 3. I/O interface 210 communicatively couples client 140 to network 100. Processor 220 may include an Intel Pentium® processor or other processor and processes programs stored in memory 200. Display 230 may include a monitor or other device for displaying data. Input device 240 may include a mouse, trackball, keyboard or other input device or combination thereof.

FIG. 3 illustrates a block diagram of a representative memory device 200 according to an embodiment of the invention. Memory 200 includes an operating system (O/S) 300, such as Windows NT®; a web browser 310, such as Internet Explorer; a Dynamic Multi Web View (DMWV) Object Converter Engine 320; and a DMWV Operating Program 330. In one embodiment, memory 200 may also comprise an advertisement library 325 that includes advertisements for display. Advertisements may be in HTML, XML, or any other language or combination of languages and may also include a web address for click-throughs. In an embodiment of the invention, engine 320 may be installed within browser 310, thereby expanding the functionality of browser 310.

Engine 320 and program 330 are described in U.S. patent application Ser. No. ______, filed ______, entitled “System and Method for Aggregating Website Contents” by inventor Byung Joon Park, which is hereby incorporated by reference, and enable a user to aggregate user-selected portions of one or more web pages into a single file. For example, the DMWV Operating Engine 320 and Program 330, as disclosed in the above-mentioned application, enable a user to select portions of one or more web pages and incorporate the portions into a file for later viewing. The DMWV Operating Engine 320 and Program 330 calculate coordinates of a user-selected portion of a web page and store the coordinates, along with a web page address, in a file. When a user loads and views the file, the Operating Engine 320 and Program 330 loads the web page and filters the received content so as to only display content specified by the stored coordinates.

For example, engine 320 and program 330 may aggregate a search box from Yahoo!, a local weather forecast from the Weather Channel, and top headlines from CNN into a single file. Engine 320 and program 330 perform the aggregation by calculating coordinates of the user-selected content and storing the coordinates and associated web page addresses in a file. In addition, the engine 320 and program 330 may also store display coordinates associated with the user-selected content for displaying the content at user-specified locations.

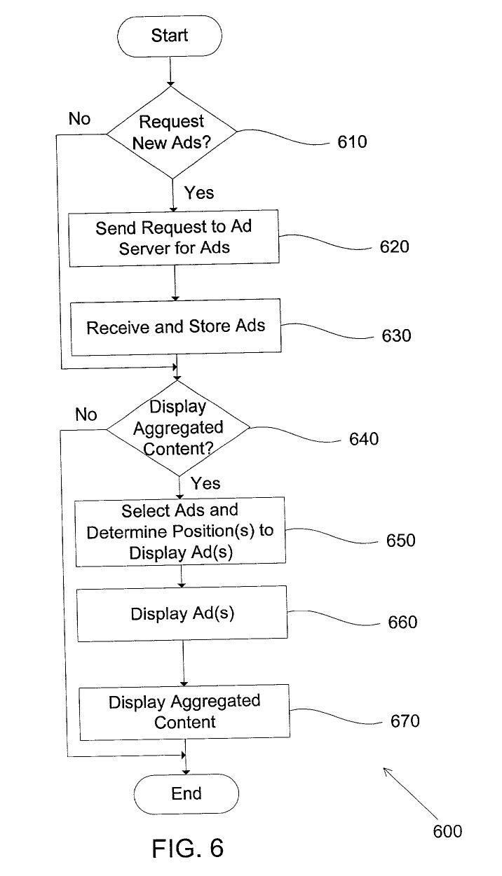

In addition to performing the aggregation discussed above, engine 320 and program 330 may also display advertisements concurrently with displaying the user-selected content. In an alternative embodiment, an advertising engine (not shown) may select and display advertisements concurrently with displaying the user-selected content. In one embodiment, the engine 320 and program 330 may first download advertisements from one or more ad servers 150 and store the advertisements locally. During creation, editing or viewing of an aggregated content file, the engine 320 and program 330 may select one or more advertisements and display the one or more advertisements with the aggregated content. Alternatively, engine 320 and program 330 may download advertisements concurrently with downloading aggregated content and display one or more of the advertisements concurrently with displaying the aggregated content. The downloading and displaying of advertisements will be discussed in more detail in conjunction with FIG. 6.

FIG. 4 is a block diagram illustrating an ad server 150 according to an embodiment of an invention. Server 150 may include a memory device 400, I/O 410, and processor 420, all communicatively coupled together via system bus 430. In an embodiment of the invention, server 150 may also include an input device (not shown) and/or a display (not shown). Memory device 400 stores software to transmit one or more advertisements to clients upon request. Contents of memory 400 will be discussed in further detail in conjunction with FIG. 5. I/O 410 communicatively couples server 150 to network 100 so that server 150 may communicate with clients, such as client 140. Processor 420 may be an Intel Pentium® processor or other processor and executes software stored in memory 400.

FIG. 5 illustrates a block diagram of a memory device 400 according to an embodiment of the invention. Memory 400 includes O/S 500, web server 510, server engine 520, and library 530. O/S 500 may include Windows NT®, Linux, or any other operating system. Web server 510 serves advertisements from ad library 530 to clients. Server engine 520, in an embodiment of the invention, may receive requests from client 140 for advertisements and select advertisements from ad library 530 to serve to clients. Library 530 may store one or more advertisements from one or more advertising agencies, such as DoubleClick, Inc., which represents a plurality of corporations and/or corporations directly.

FIG. 6 is a flowchart illustrating a method 600 for inserting advertising into user-selected web content. In an embodiment of the invention, engine 320 and program 330 may execute method 600. First, it is determined (610) whether to request new advertisements. If new advertisements are to be requested, then a request for advertisements is sent (620) to an advertising server, such as server 150, or to a plurality of servers hosting advertisements. One or more advertisements are then received (630) and stored (630) locally.

If no advertisements are to be requested, or after advertisements are received (630) and stored (630), it is determined if an aggregated content page is to be displayed (640). Displaying includes opening a previously saved file for viewing, opening a previously saved file for editing, and/or creating a new file for aggregating content. If an aggregated content page is not to be displayed, the method 600 ends. Otherwise, advertisements are selected (650) from, for example, ad library 530, or, in a different embodiment, directly from an ad server, such as ad server 150. Selection of advertisements can be random, based on demographic data of a user, user-selected content, and/or other factors. Further, based on the selected advertisements, one or more placement locations for one of more of the selected advertisements are determined (650). The advertisements are then displayed (660). Next, the page is displayed (670) as described in the above-mentioned patent application entitled “System and Method for Aggregating Website Contents,” which includes loading an aggregated content page, loading web pages corresponding to addresses stored in the page, and filtering the web pages per stored coordinates so as to display only user-selected content from the web pages. Typically, the advertisements are displayed above the filtered web content or filtered web contents are displayed under the advertisements.

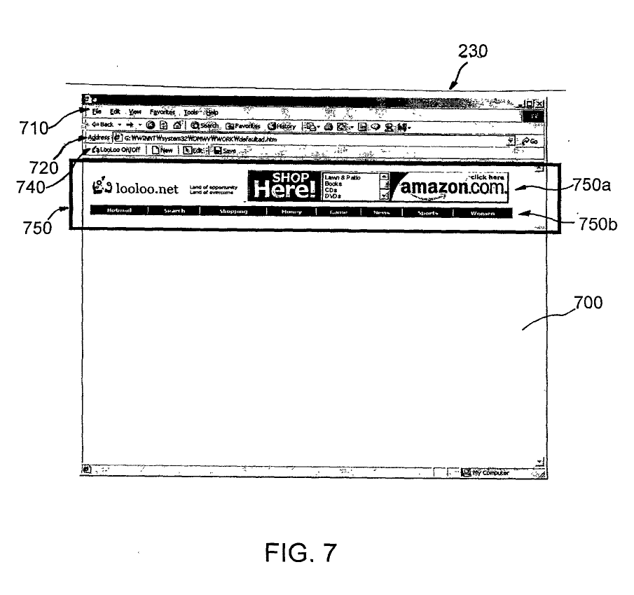

FIG. 7 is a diagram illustrating an example of inserted advertising on a display device 230. In the example of FIG. 7, a web browser 310 is opened and displaying a new page 700 for aggregating user-selected content from one or more web pages. Included on the display 230 are a menu 710, an address field 720, an engine 320 menu 740, and an inserted advertisement 750. Menu 740 includes an On/Off toggle button for turning on and off the functions of engine 320. Menu 740 further includes buttons to create a new page/file of aggregated user-selected content, edit a pre-existing page, and saving a page. Advertisement 750 includes a banner advertisement 750a for Amazon.com and a directory-type advertisement 750b for MSN. In an embodiment of the invention, any type of advertisement may be used with engine 320, and engine 320 may place advertisements at any location within page 700. Further, if a user clicks through an advertisement, engine 320 will load a web page corresponding to the advertisement.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A client-side method, comprising:
obtaining a user-selected web portion from a web page;
displaying the user-selected web portion;
initiating acquisition of an advertisement; and
displaying the advertisement with the user-selected web portion.

2. The method of claim 1, wherein the advertisement includes a banner advertisement.

3. The method of claim 1, wherein the advertisement includes a directory-type advertisement.

4. The method of claim 1, wherein the initiating acquires an advertisement based on demographic data of the user.

5. The method of claim 1, wherein the initiating acquires an advertisement based on the at least one user-selected portion.

6. The method of claim 1, wherein the initiating acquires an advertisement from an advertisement server.

7. The method of claim 1, wherein the initiating acquires an advertisement from a locally stored library of advertisements.

8. A machine-readable medium having stored thereon instructions to:
obtain a user-selected web portion from a web page;
display the user-selected web portion;
initiate acquisition of an advertisement; and
display the advertisement with the user-selected web portion.

9. The machine-readable medium of claim 8, wherein the advertisement includes a banner advertisement.

10. The machine-readable medium of claim 8, wherein the advertisement includes a directory-type advertisement.

11. The machine-readable medium of claim 8, wherein the instruction to initiate acquires an advertisement based on demographic data of the user.

12. The machine-readable medium of claim 8, wherein the instruction to initiate acquires an advertisement based on the at least one user-selected portion.

13. The machine-readable medium of claim 8, wherein the instruction to initiate acquires an advertisement from an advertisement server.

14. The machine-readable medium of claim 8, wherein the instruction to initiate acquires an advertisement from a locally stored library of advertisements.

15. A system, comprising:
means for obtaining a user-selected web portion from a web page;
means for displaying the user-selected web portion;
means for initiating acquisition of an advertisement; and
means for displaying the advertisement with the user-selected web portion.

16. An apparatus, comprising:
a memory device;
a client engine, communicatively coupled to a network and to the memory device, capable to obtain a user-selected web portion from a web page; display the user-selected web portion; and
an advertising engine, communicatively coupled to the client engine and the network, capable to initiate acquisition of an advertisement and display the advertisement with the user-selected web portion.

17. The apparatus of claim 16, wherein the advertisement includes a banner advertisement.

18. The apparatus of claim 16, wherein the advertisement includes a directory-type advertisement.

19. The apparatus of claim 16, wherein the advertising engine is capable to initiate acquisition of the advertisement based on demographic data of the user.

20. The apparatus of claim 16, wherein the advertising engine is capable to initiate acquisition of the advertisement based on the user-selected portion.

21. The apparatus of claim 16, wherein the advertising engine is capable to initiate acquisition of the advertisement from an advertisement server communicatively coupled to the network.

22. The apparatus of claim 16, wherein the memory further comprises a library of advertisements.

23. The apparatus of claim 22, wherein the advertising engine is capable to initiate acquisition of the advertisement from the library.
